(19) United States
(12) Patent Application Publication
(10) Pub. No.: US 2003/0101210 A1
(43) Pub. Date: May 29, 2003

(54) Method and appratus for selectively forwarding a file to a communications device

(75) Inventors: Robert Gary Goodman, Double Oak, TX (US); Babu Gopalakrishnan, Keller, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 09/994,644

(22) Filed: Nov. 28, 2001

(51) Int. Cl. G06F 15/16

(52) U.S. Cl. 709/202; 709/219

(57) ABSTRACT

Apparatus and method of selectively forwarding a file to a consumer of the file, that includes retrieving the file from a server; evaluating the file to determine whether resources required for utilization of the file are available; forwarding the file to the consumer when the resources are available; and forwarding a message corresponding to the file to the consumer of the file when the resources are unavailable.

### FIELD OF THE INVENTION

This invention relates in general to communication systems, and more specifically to a method and apparatus for selectively forwarding a file to a communications device

### BACKGROUND OF THE INVENTION

Generally networks when a file is requested forward the file unless network resources are not available and in the latter case a would be user waits until the resources are available or goes on to something else. Often times the files are forwarded to a requester or user only to find out that the local resources needed to utilize the file are not available, thus wasting time and network resources or needlessly incurring costs.

Agents or proxies for communications devices, particularly wireless devices have been discussed. These agents are usually software programs operating on gateways that attempt to forward a file in a form that is usable by the communications device. For example a complex graphic may be converted to a simple graphic or not forwarded at all when the device requesting the file does not have enough display capability to show the graphic. However these agents do not provide any indication to a user that something has not been forwarded due to limited or unavailable resources.

Clearly a need exists for methods and apparatus for selectively forwarding files in order to provide better information and options to users of devices requesting such files.

### BRIEF DESCRIPTION OF THE DRAWINGS

The accompanying figures, where like reference numerals refer to identical or functionally similar elements throughout the separate views and which are incorporated in and form part of the specification, serve to further illustrate various embodiments in accordance with the present invention. The figures together with the detailed description, hereinafter below, serve to explain various principles and advantages in accordance with the present invention.

FIG. 1 depicts, in a simplified and exemplary form, a block diagram of a communications system suitable for utilizing the present invention;

FIG. 2 depicts, in block diagram form, a preferred embodiment of a communications device according to the present invention;

FIG. 3 illustrates, in block diagram form, a preferred embodiment of a gateway in accordance with the present invention;

FIG. 4 depicts exemplary messages available at the FIG. 2 device according to the instant invention; and

FIG. 5 depicts a preferred method embodiment of selectively forwarding files according to the present invention.

### DETAILED DESCRIPTION OF PREFERRED EMBODIMENT

In overview form the present disclosure concerns communications systems that provide service to communications units or more specifically users thereof operating therein. More particularly various inventive concepts and principles embodied in methods and apparatus for selectively forwarding files only when suitable resources are available for using these files are discussed. The communications systems of particular interest are typically wireless systems in part and will include communications devices having access to the Internet or World Wide Web or similar networks. Systems such as GPRS systems presently being deployed or those being planned that employ IPv6 such as 3^{rd} generation IP based systems or other systems using IP addressing and allowing for mobility of the communications devices or end users thereof will be especially suitable for using embodiments in accordance with the present invention. As further discussed below various inventive principles and combinations thereof are advantageously employed to essentially forego downloading or forwarding files until suitable resources are available and providing users with appropriate messages and preferably choices in the meantime, thus alleviating various problems associated with known systems while still facilitating proper and useful file forwarding provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

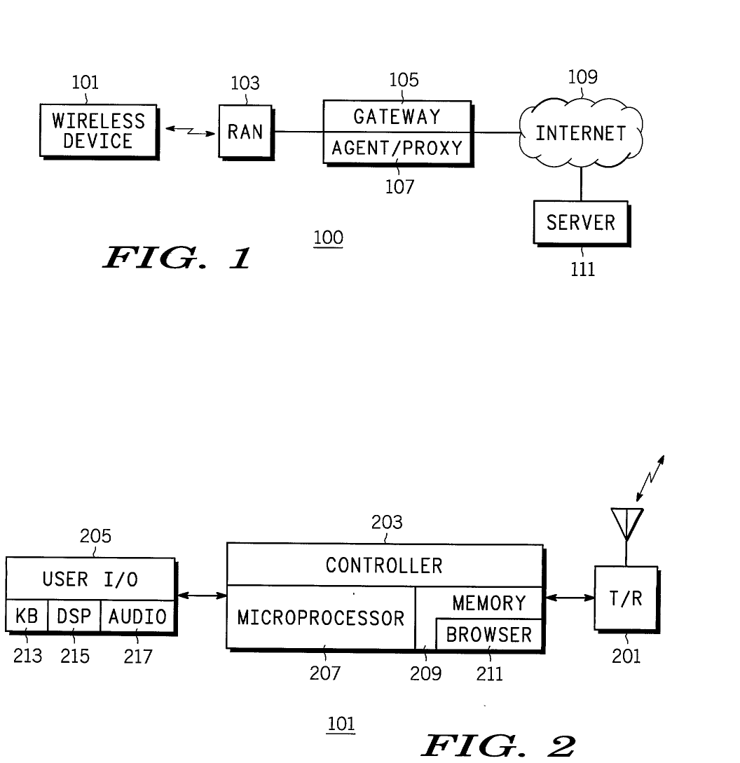

FIG. 1 depicts in a simplified and exemplary form a block diagram of a communications system suitable for employing various embodiments according to the present invention. A wireless device 101 is coupled by a wireless link to a radio access network (RAN) 103. The RAN 13 is further coupled to a gateway 105 that includes an agent or proxy 107 that operates on behalf of the wireless device 101. The gateway operates to couple the RAN, thus wireless device, via the Internet 109 or World Wide Web or similar network to various servers 111 (one depicted). These servers are used to store files that may be of interest to the wireless device.

In operation, as known, the wireless device requests a file by sending a URL or address via the RAN, gateway and Internet to a destination server 111. The server returns a file corresponding to the URL for the wireless device to the gateway. Various known and being developed protocols are used for the various links shown in FIG. 1. For example, the RAN is preferably a General Packet Radio System (GPRS) where the wireless device 101 is always “connected” to the RAN. Note that the present principles and concepts have equal applicability to other RANs such as the Motorola iDEN system or future system known as 3+G systems that are using IPv6 or equivalents. In this instance the GPRS RAN uses an IP based packet data protocol such as TCP/IP or HTTP at the application level. Here the RAN is depicted as a block but it is understood that an actual RAN will be comprised of a multiplicity of transceivers deployed to cover a wide area as well as various transceiver controllers, switches and schedulers all operating to manage and schedule traffic over or through the RAN. Certain aspects of the present invention require that the RAN 103 and the gateway 105, specifically agent 107, communicate or interact to determine the availability of resources for transporting files that are being forwarded to the wireless device.

Referring to the FIG. 2 block diagram an embodiment of a communications device or wireless device 101 according to the present invention will be discussed. The wireless device may be a personal digital assistant (PDA), a messaging device, a portable phone, a wireless equipped hand held computer, or the like so long as the device is arranged to operate with the RAN and modified in accordance with the principles and concepts disclosed herein. Typically these wireless devices will have certain resources that are constrained or finite or limited and often quite limited. This is the result of a premium being placed on size, weight, and battery life for the sake of portability. For example most cellular or portable phones have very limited display capability plus limited memory and processing capacity. PDAs and messaging devices may have more capable displays with hand held computers possibly even more capable and portable computers with less if any significant limitations other than battery life.

The wireless device 101 includes a known transceiver 201 that is arranged and constructed to compatibly operate with the RAN 103. Coupled to and controlling the transceiver is a controller 203. The controller is further coupled to a user I/O function 205. The controller 203 includes a general-purpose processor 207 such as micro processors available from Motorola, Intel, etc. with varying levels of performance dependent on device functions and features not here relevant. The controller 203 will also include a memory 209 that is some combination of RAM, ROM, EEPROM, memory card, or magnetic memory such as a hard drive etc.

The memory is used to store software instructions and various data that when executed and utilized by the processor result in appropriate control of the transceiver and wireless device and interaction with the user I/O. The data will include among others various device characteristics that specify, for example, display characteristics or limitations, processing capacity, audio processing capabilities and any file size limitations or download time limitations and any rules regarding downloads such as no downloads exceeding 1K from 7-9 AM or 4-6 PM and the like. The memory will also include a program typically known as a Browser 211 that facilitates interaction between a user and the servers 111 on the Internet. In accordance with the present disclosure the Browser further facilitates interaction with the Agent 107 and the user I/O 205 as will be further discussed below. The combination of the browser and the wireless device is the reason the device may be referred to as a wireless browser.

The user I/O includes a keyboard function 213 that may include some form of a keyboard including touch pad and mouse or a few buttons by which the use may interact with the device, a display 215 that may range from a few lines with limited number of characters to a general purpose color portable computer display, etc. Also shown is an audio function 217 that can include speakers and microphones as well as various audio file processing capability such as the ability to process and utilize a wav or midi files. As the reader will note it is contemplated that wireless devices, such as 101 will have widely varying resources and thus widely varying capability to utilize files that may be received or downloaded from the Internet.

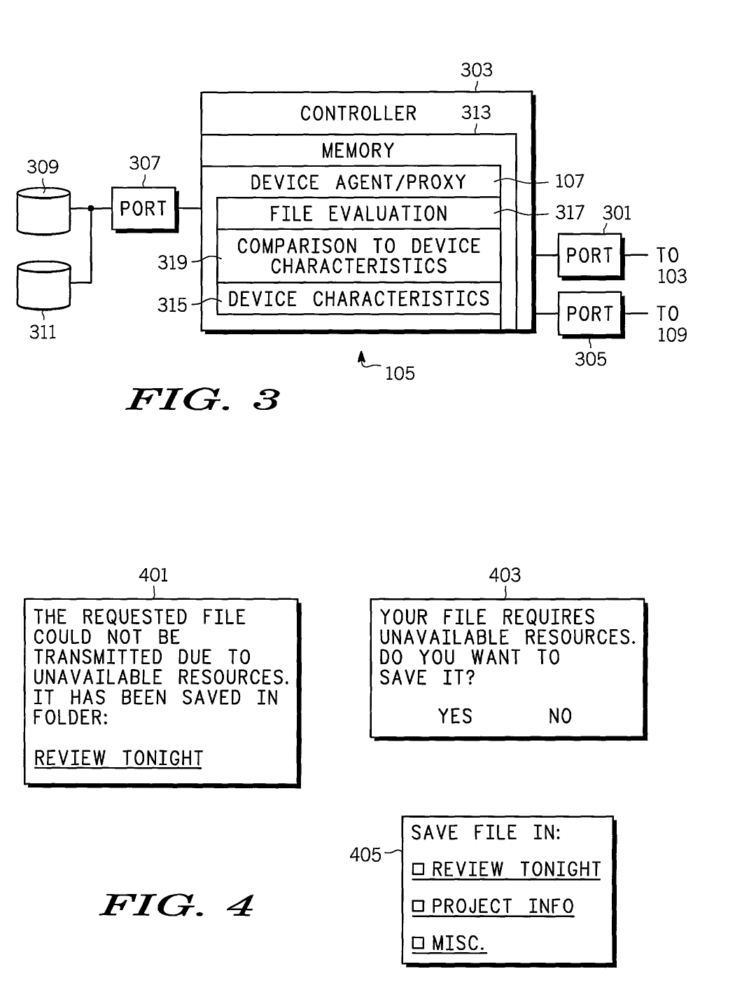

Referring to the FIG. 3 block diagram a preferred embodiment of the gateway 105 in accordance with the present invention will be discussed. Generally the gateway 105 handles, manages, and routes messages and files being exchanged between the RAN and the Internet including translation if any. Physically it may resemble any other router or server and is available from manufacturers such as Motorola, Cisco, etc. When modified according to the principles and concepts disclosed herein including the agent or proxy 107 the gateway will provide the advantages further noted below. The gateway includes a plurality of ports such as port 301 arranged to couple to the RAN 103, port 305 arranged to couple to the Internet 109 and port 307 suitably configured to couple to various storage facilities such as databases or servers 309 and 311. Note that 309 and 311 may be part of the gateway or may be other servers that are available via the Internet much as server 111.

Also included in the gateway, as the heart of the unit, is a controller 303 that is a general-purpose computer including processor(s) and memory 313. The memory 313 will be a combination of RAM, ROM, PROM or EEPROM, and mass or magnetic storage such as a hard drive. The memory will contain software instructions and parameters that when executed and utilized will cause the gateway to function appropriately and which are not further relevant to our purposes other than as discussed below. The memory will also include the device agent or proxy 107 that is preferably a software program that operates on behalf of the wireless device or devices to provide the advantages noted herein. This agent 107 will have access to or include a file evaluation 317 routine, a device characteristics and rules database 315 and a routine for comparing results of the file evaluation to the device characteristics or capabilities 319. These device characteristics and rules database are loaded into the gateway at the time the device is originally configured or registered with the gateway and this may be done over the air by sending this information from the device to the gateway in known ways not here further relevant.

In operation the gateway selectively forwards files to the wireless or communications device. The gateway via its port 301 and the RAN communicates with the communications device and via its port 305 communicates with a server. The gateways controller, coupled to the ports, operates as an agent for the communications device. When the communications device or wireless device requests a file by for example forwarding a URL, the gateway or agent will retrieve the file from the server by forwarding the URL to and receiving the response or file from the server. The agent 107 software using the file evaluation 317 routine will evaluate the file pursuant to determining whether resources required for utilization of the file are available, for example, at the wireless device or within the RAN. If such resources are available and no rules, such as excessive download times or wrong time to download, established by the device have been or will be infringed, the file is forwarded to the communications or wireless device. If rules are infringed or resources are not available, a message, corresponding to the file, is forwarded to the communications device.

Evaluating the file to determine whether resources are available includes assessing the file for, for example, overall size, graphic or video or audio content. These file parameters will effect download times, post transport processing capacity and display capability required for the file from the wireless device. Often these parameters are available by analyzing a file header in, for example, an HTML file or by looking for jpeg or mpeg or wav files within the overall file. Once the parameters are determined the resource required of a communications unit or wireless device for utilization of the file are known. A comparison with the device characteristics of the particular wireless device is performed using the routine 319 and the result tells whether such resources are available.

One further optional process in evaluating the file to determine whether resources are available includes assessing or determining whether radio network resources are available to transport the file. This will include determining whether a channel with an appropriate quality of service (QOS) or certain attributes thereof is available for transporting the file. For example, if the file is large a large bandwidth channel may be required or excessive download times and battery consumption by the wireless device can occur. If particularly sensitive information is being transported such as financial information a channel with a good bit error rate may be required. Two approaches are contemplated for determining the radio resource availability. One is forwarding the file to the RAN requesting certain QOS parameters and waiting for a negative response. The other is interacting with the RAN to determine resource or channel availability before forwarding the file.

In any event if appropriate resources are not available either at the RAN or at the wireless device the gateway 105 or agent 107 forwards the message corresponding to the file. This message may take any number of forms and certain ones are displayed in FIG. 4. One possible message not depicted is “The requested file could not be transmitted (or retrieved) due to unavailable resources.” Another shown at 401 indicates a problem but notes that the file (optional URL or address) has been saved in a folder or on a server or the like here called or named Review tonight. The message at 403 provides the user a message indicating that appropriate resources are unavailable and asking whether the file (or an address for the file) should be saved. If the user responds with a yes a message would be returned to the agent and the agent can store the file or address in a predetermine location or respond to the wireless device with a message similar to the one at 405 that provides a choice of locations, such as 309, 311 for storing the file or address for the file.

One further notion is providing a reminder at the wireless device preferably triggered by the gateway or agent. This reminder could take various known forms such as a blinking icon or periodically displaying one of the messages in FIG. 4 or a message “read Review Tonight folder”. The reminder may also be an email message containing the reminder or URL or address of the file to be viewed later. The reminder need not be triggered at the wireless device or only at the wireless device but may also be triggered at a second communications device. The second communications device or target for the trigger or email, as above, may be selected from a list of choices, such as home, office, or both, offered by the agent. The agent could as well track whether the file had been accessed in such a location and when it had been turn off or cause to be turned off this reminder. Note: it is understood that the communications system 100 nearly always has signaling channel capacity but may on occasion have limited payload channel capacity.

In summary form, the communications device 101 retrieves files from the network or Internet and as noted above includes the transceiver for interfacing to the RAN, the user I/O including the display; and the controller that includes a browser. The browser operates to request a file located at a network server, receive the file when resources for utilization of the file are available at the device, and receive a message corresponding to the file when such resources are unavailable. The message is coupled to the display and preferably offers a choice of saving the file or an address for the file. The message may offer a choice of locations for saving the file or address for the file. And the device preferably displays a reminder until the file has been accessed or received. Note the file need not be received on the wireless device but rather in most case will be received on a device with greater resources. Once the file has been accessed or received the agent will disable the reminder on the wireless device.

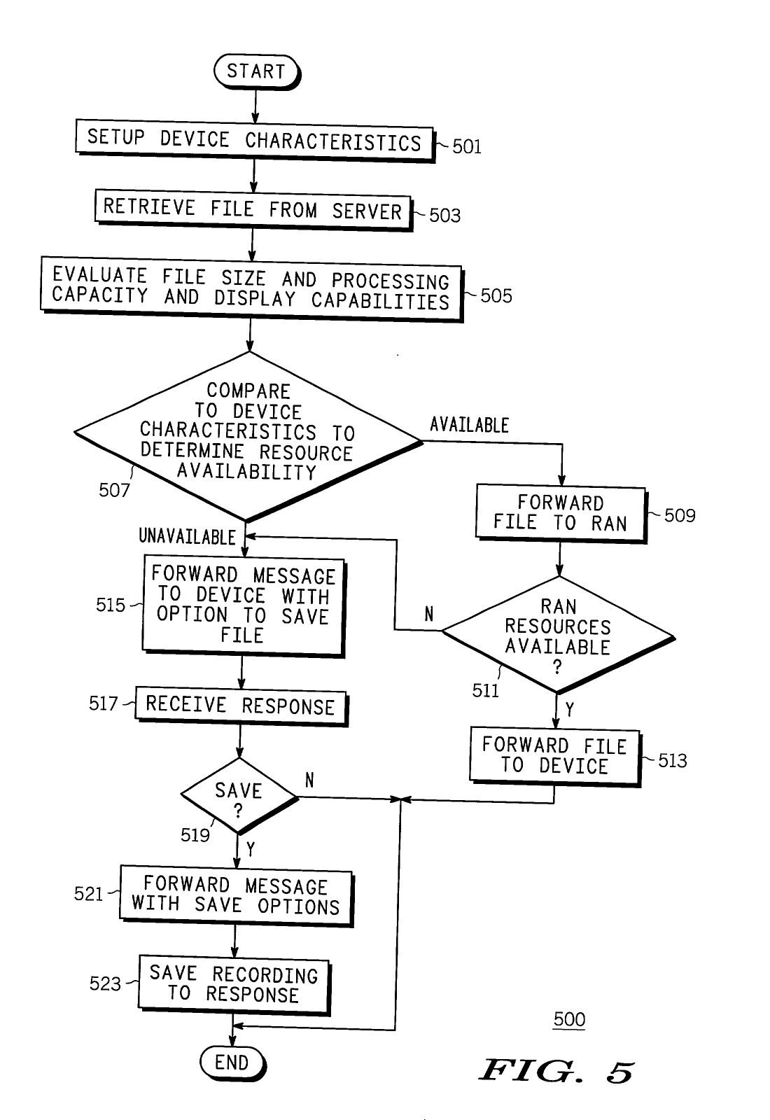

FIG. 5 depicts a preferred method 500 embodiment of selectively forwarding files according to the present invention. A discussion of this FIG will serve as somewhat of a review of the above material. The method of selectively forwarding a file to a consumer of the file begins at 501 with setting up device characteristics, for example at ana gent for a wireless device. At 503 retrieving the file from a server is undertaken and at 505 evaluating the file to determine whether resources required for utilization of the file is initiated. Such things as file size, graphic, video, audio, etc. content and processing capacity and display capabilities are assessed thus determining what communications unit resources will be required for utilization of the file.

At 507 the device characteristics are compared to the file attributes to determine whether proper resources are available. If so at step 509 the file is forwarded to the RAN or next step in the network serving the consumer. Given that device resources are available and if radio or other network resources, such as a channel with appropriate quality of service, are available to transport the file as tested at 511 the file is forwarded to the consumer or wireless device. If resources are unavailable from 507 or 511 a message corresponding to the file is forwarded to the consumer of the file or here a wireless device at 515. Preferably this message indicates that appropriate resources are unavailable and asks the user or consumer of the file whether the file or an address for the file should be saved for later consumption. Also if the response to that message is received at 517 and affirmative as tested at 519, an optional message providing a choice of locations for storing the file or address may be provided at 521 and the message saved according to the response to this message at 523. Furthermore after saving the message at 523 a reminder corresponding to the file as saved for the consumer may be activated at the communications unit and removed or disabled once the file has been accessed. When the response at 519 is negative or after saving the file at 523 or forwarding the file at 513, the method ends.

The processes, systems, communications units or wireless devices, and gateways, discussed above, and the inventive principles thereof are intended to and will alleviate problems caused by prior art file handling when resources were inadequate for proper consumption of the file. Using these principles and concepts for forwarding files but only when the device has the resources to utilize the files will reduce network traffic and provide a more user-friendly experience thus facilitating wireless connectivity for mobile individuals. This is particularly true with the concept of forwarding a message that is relevant to the current circumstances and offers the user various choices for dealing with the file in addition to reminders concerning the file. Furthermore the principles and concepts discussed here can be applied to not only resource limitations but rule based file handling as well. By selecting, using rule based decisions by an agent, when and under what circumstances a file is down loaded or forwarded it is anticipated that economic benefits will follow.

Various embodiments of methods, systems, and apparatus for selectively forwarding files depending on resource availability so as to facilitate and provide for a more user friendly experience have been discussed and described. It is expected that these embodiments or others in accordance with the present invention will have application to many wired and wireless wide area networks that provide file downloads or file retrieval or forwarding services to their user or subscriber devices or units as well as local area networks that are coupled to fixed WANS such as the PSTN or internet. The disclosure extends to the constituent elements or equipment comprising such systems and specifically the methods employed thereby and therein. Using the inventive principles and concepts disclosed herein advantageously allows or provides for low latency and low network overhead access to files on as useful basis which will be beneficial to users and providers a like.

This disclosure is intended to explain how to fashion and use various embodiments in accordance with the invention rather than to limit the true, intended, and fair scope and spirit thereof. The invention is defined solely by the appended claims, as may be amended during the pendency of this application for patent, and all equivalents thereof.

What is claimed is:

1. A method of selectively forwarding a file to a consumer of the file, the method including the steps of:
retrieving the file from a server;
evaluating the file to determine whether resources required for utilization of the file are available
forwarding the file to the consumer when said resources are available; and
forwarding a message corresponding to the file to the consumer of the file when the resources are unavailable.

2. The method of claim 1 wherein said step of evaluating said file includes a step of assessing whether network resources are available to transport said file.

3. The method of claim 2 wherein said step of assessing further includes determining whether a channel with appropriate quality of service is available for transporting said file.

4. The method of claim 1 wherein said step of evaluating said file includes a step of assessing communications unit resources required for utilization of said file.

5. The method of claim 4 wherein said step of assessing said communications unit resources includes determining one of a size of the file, a graphic content of the file, a post transport processing capacity corresponding to the file, and a display capability required for the file.

6. The method of claim 1 wherein said step of forwarding said message corresponding to the file includes forwarding a message indicating that appropriate resources are unavailable and asking the consumer whether one of the file and an address for the file should be saved for later consumption.

7. The method of claim 6 further including a step of forwarding a message that provides a choice of locations for storing said one of the file and said address for the file.

8. The method of claim 6 further including triggering a reminder corresponding to said file for the consumer at a communications unit and removing said reminder when said file has been accessed.

9. A communications device for retrieving files from a network, the communications device comprising in combination;
a transceiver for interfacing to a radio access network;
a user input output (I/O) including a display; and
a controller, coupled to said transceiver and said user I/O, further comprising a browser that operates to;
request a file located at a network server,
receive the file when resources for utilization of the file are available, and
receive a message corresponding to the file when said resources are unavailable.

10. The communications device of claim 9 wherein said message is coupled to said display and offers a choice of saving one of said file and an address for said file.

11. The communications device of claim 10 wherein said message offers a choice of locations for saving said one of said file and said address for said file.

12. The communications device of claim 9 wherein a reminder corresponding to said file is shown on said display until said file is received.

13. A gateway operating to selectively forward files to a communications device, the gateway comprising in combination:
a first port arranged to communicate with the communications device;
a second port arranged to communicate with a server; and
a controller, coupled to said first port and to said second port, operating as an agent for the communications device for;
retrieving a file from said server;
evaluating said file to determine whether resources required for utilization of said file are available;
forwarding said file to the communications device when said resources are available; and
forwarding a message corresponding to said file to the communications device when the resources are unavailable.

14. The gateway of claim 13 wherein evaluating said file includes a assessing whether radio network resources are available to transport said file.

15. The gateway of claim 14 wherein said assessing further includes determining whether a channel with appropriate quality of service is available for transporting said file.

16. The gateway of claim 13 wherein said evaluating said file includes a step of assessing communications device resources required for utilization of said file.

17. The gateway of claim 16 wherein said step of assessing said communications device resources includes determining one of a size of said file, a graphic content of said file, a post transport processing capacity corresponding to said file, and a display capability required for said file.

18. The gateway of claim 13 wherein said forwarding said message corresponding to said file includes forwarding a message indicating that appropriate resources are unavailable and asking whether one of the file and an address for the file should be saved.

19. The gateway of claim 18 further operating to forward a message that provides a choice of locations for storing said one of the file and said address for the file.

20. The gateway of claim 18 further operating to trigger a reminder corresponding to said file at the communications device and removing said reminder when said file has been received.

21. The gateway of claim 18 further operating to trigger a reminder corresponding to said file at a second communications device.

22. The gateway of claim 21 wherein said reminder includes sending an email too said second communications device, said email including a URL for said file.
